(19) United States
(12) Patent Application Publication
(10) Pub. No.: US 2012/0013759 A1
(43) Pub. Date: Jan. 19, 2012

(54) ELECTRONIC DEVICE AND METHOD FOR CAPTURING IMAGES

(75) Inventor: WEI-YUAN CHEN, Tu-Cheng (TW)

(73) Assignee: HON HAI PRECISION INDUSTRY CO., LTD., Tu-Cheng (TW)

(21) Appl. No.: 12/978,414

(22) Filed: Dec. 24, 2010

(30) Foreign Application Priority Data
Jul. 14, 2010 (CN) 201010226587.X

(51) Int. Cl. H04N 5/225

(52) U.S. Cl. 348/222.1; 348/333.04; 348/E05.024

(57) ABSTRACT

An electronic device and a method for capturing images include detecting the face area of a monitored scene and reading image data of the face area in an image of the monitored scene captured by the camera device. The method further includes calculating a definition value of the face area in the image according to the read image data, and displaying a prompt message of recapturing the image on a display of the electronic device, upon the condition that the calculated definition value is lower than or equal to a predetermined definition threshold value.

### BACKGROUND

1. Technical Field

Embodiments of the present disclosure relate to image management, and in particular, to an electronic device and method for capturing images using the electronic device.

2. Description of Related Art

When an electronic device, such as a digital camera and a mobile phone, is used to capture images, the images may be unclear if a face of a person of the captured image is blurred. For example, this situation can happen if an image to be captured moves or a photographer shakes the electronic device during capture of the image. Because the images are limited by the size of a display of the electronic device, it is hard to determine whether the captured image is clear on the display of the electronic device. The images may be determined to be unclear after they have been copied to a computer. However, the image cannot be made clear at this time.

### BRIEF DESCRIPTION OF THE DRAWINGS

FIG. 1 is a block diagram of one embodiment of an electronic device including a management system.

FIG. 2 is a block diagram of one embodiment of the management system of FIG. 1.

FIG. 3 is a schematic diagram of one embodiment of the management system calculating a definition value of FIG. 1.

FIG. 4 is a flowchart of one embodiment of a method for capturing images in an electronic device, such as, for example, that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, for example, Java, C, or Assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system.

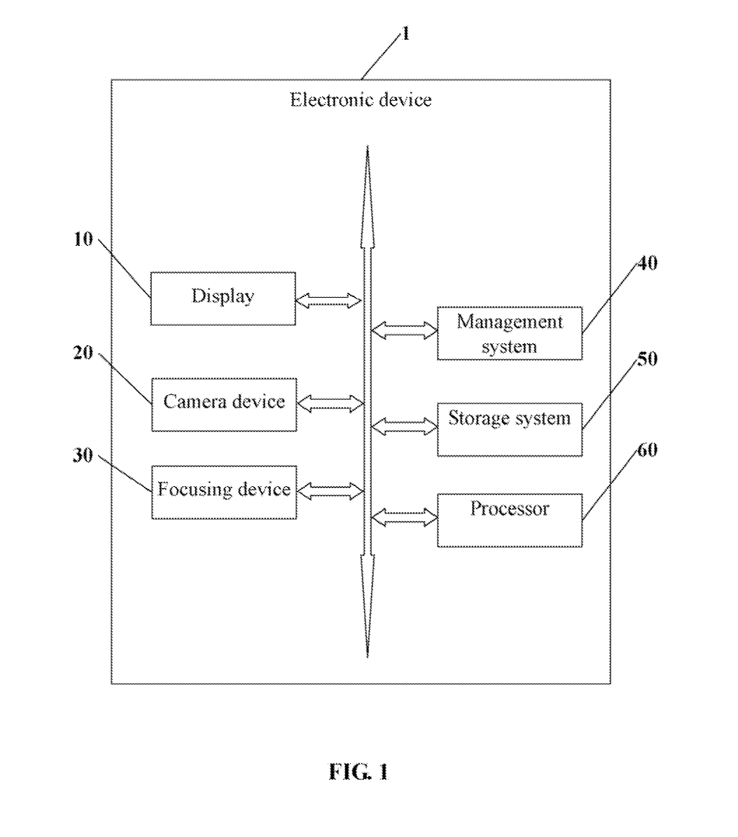

FIG. 1 is a block diagram of one embodiment of an electronic device 1 including a management system 40. The management system 40 may prompt a user to capture an image of a monitored scene again, if a face area (i.e., area of a human face) of the monitored scene is detected to be blurry. The electronic device 1 further includes a camera device 20 and a focusing device 30. The camera device 20 may capture an image of the monitored scene. In some embodiments, the camera device 20 may be a charge-coupled device (CCD). For example, when a user presses a camera button (not shown in FIG. 1) of the electronic device 1, the camera device 20 may capture the image of the monitored scene. The focusing device 30 may focus the face area to make the face area clearer automatically. In some embodiment, the focusing device 30 may be a sensor system or an autofocus system of the electronic device 1. The focusing device 30 may use a principle of light reflection to focus the face area.

The electronic device 1 further includes a display 10, a storage system 50 and at least one processor 60. The display 10 may output visible data, such as preview scenes to be captured, or photographs of the electronic device 1, for example. The storage system 50 may store various data, such as the captured images of the electronic device 1. The storage system 50 may be a memory system of the electronic device 1, and may be an external storage card, such as a smart media (SM) card, or secure digital (SD) card, for example. The at least one processor 60 executes one or more computerized code of the electronic device 1 and other applications, to provide the functions of the electronic device 1.

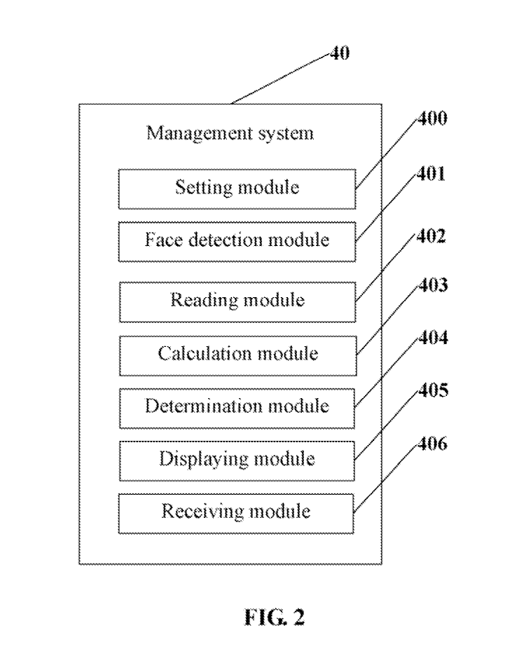

FIG. 2 is a block diagram of one embodiment of the management system 40 of FIG. 1. In some embodiments, the management system 40 includes a setting module 400, a face detection module 401, a reading module 402, a calculation module 403, a determination module 404, a displaying module 405, and a receiving module 406. The modules 400-406 may comprise computerized code in the form of one or more programs that are stored in the storage system 50. The computerized code includes instructions that are executed by the at least one processor 60 to provide functions for modules 400-406. Details of these operations follow.

The setting module 400 sets a definition threshold value to determine whether an image captured by the electronic device 1 is clear. The definition threshold value may be set to be a number, such as 70, for example.

The face detection module 401 detects the face area of the monitored scene and determines whether the face area has been detected. In some embodiments, the face detection module 401 detects the face area using a face template matching technology. If the face detection module 401 has detected the face area, the focusing device 30 focuses the face area to make the face area clearer automatically.

The reading module 402 read the image of the monitored scene captured by the camera device 20 and read image data of the face area in the image. The image data may include gray values of the face area.

The calculation module 403 calculates a definition value of the face area in the image according the read image data. In some embodiments, the calculation module 403 uses a Sobel algorithm based on edge detection to calculate the definition value of the face area. In other embodiments, the calculation module 403 may use an edge detection algorithm or an algorithm of frequency domain filter to calculate the definition value.

In some embodiments, the Sobel algorithm includes two Sobel operators

$$“ {G}_{X} ” = [ \begin{matrix}- 1 & 0 & + 1 \\ - 2 & 0 & + 2 \\ - 1 & 0 & + 1\end{matrix} ] * “ I ” and “ {G}_{y} ” = [ \begin{matrix}+ 1 & + 2 & + 1 \\ 0 & 0 & 0 \\ - 1 & - 2 & - 1\end{matrix} ] * “ I ” .$$

The “I” in the operators represents an initial image. The “Gₓ” is defined as the Soble operator of detecting a crosswise edge, and the “Gy” is defined as the Soble operator of detecting a longitudinal edge. Details of these operations follow.

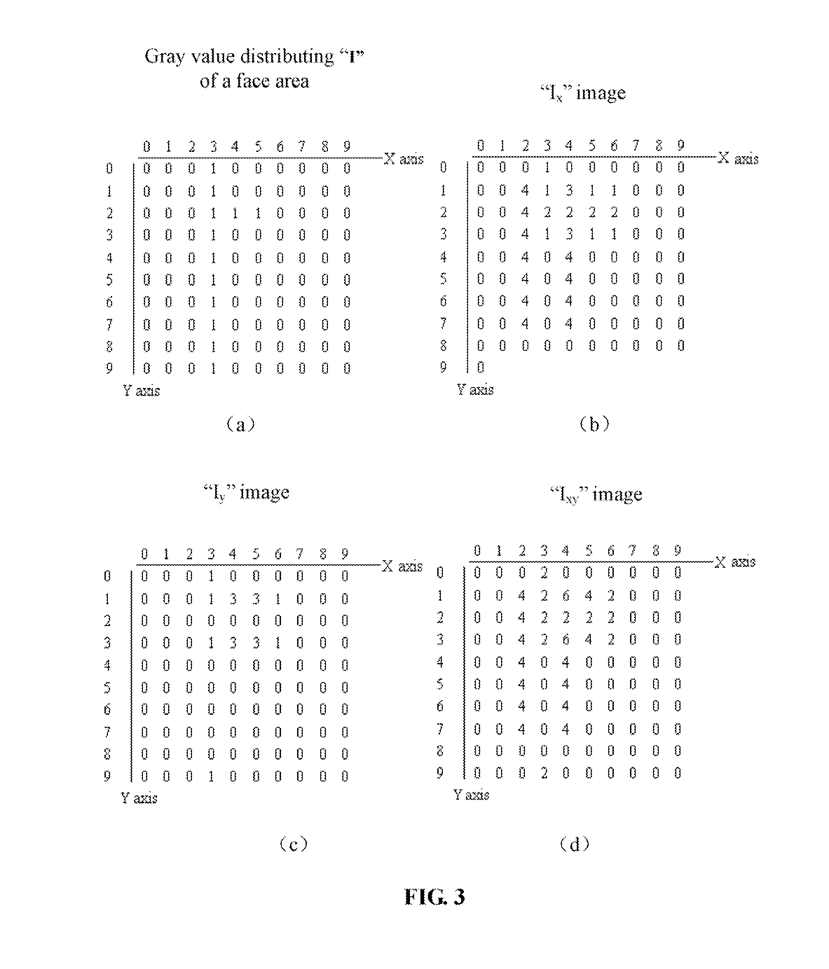

FIG. 3 is a schematic diagram of one embodiment of calculating the definition of the face area. FIG. 3(a) refers to a gray value distribution of a face area that is defined as the initial image “I,” the gray value is represented as 0 or 1. The calculation module 205 calculates the initial image “I” using the “Gₓ” Soble to obtain an “Iₓ” image, as shown in FIG. 3(b). The “Iₓ” image is equal to

$$“ [ \begin{matrix}- 1 & 0 & + 1 \\ - 2 & 0 & + 2 \\ - 1 & 0 & + 1\end{matrix} ] * I . ”$$

The calculation module 205 calculates the initial image “I” using the “G_{y}” Soble to obtain an “I_{y}” image, as shown in FIG. 3(c). The “I_{y}” image is equal to

$$“ [ \begin{matrix}+ 1 & + 2 & + 1 \\ 0 & 0 & 0 \\ - 1 & - 2 & - 1\end{matrix} ] * I . ”$$

The calculation module 205 overlays the “Iₓ” image and the “I_{y}” image to obtain an integrated “Ixy” image, as shown in FIG. 3(d). The calculation module 205 finally sums up all gray values in the integrated “Ixy” image to obtain the definition of the face area. For example, in the FIG. 3(d), the sum of the gray values is 84, thus, the definition of the face area is 84.

The determination module 404 determines whether the calculated definition value is higher than the definition threshold value.

Upon the condition that the calculated definition value is lower than or equal to the definition threshold value, the displaying module 405 displays a prompt message of recapturing the image on the display 10. For example, the displaying module 405 displays a prompt message of “Image is blurry, suggest to recapture.” The users can decide whether it is needed to recapture the image according to the prompt message, to obtain a clearer image.

The setting module 400 may further set a recapture keystroke instruction of the electronic device 1 for recapturing the image, and set a hotkey of the electronic device 1 to invoke the recapture keystroke instruction. In some embodiments, the hotkey of the electronic device 1 may be any hotkey except for a camera button of the electronic device 1.

The receiving module 406 may receive a keystroke instruction from an input system (e.g. keystrokes or virtual keystrokes) of the electronic device 1 according to user input.

The determination module 404 determines whether the received keystroke instruction is equal to the recapture keystroke instruction. If the received keystroke instruction is equal to the recapture keystroke instruction, the receiving module 406 may delete the captured image and the electronic device 1 may return to capture the image again.

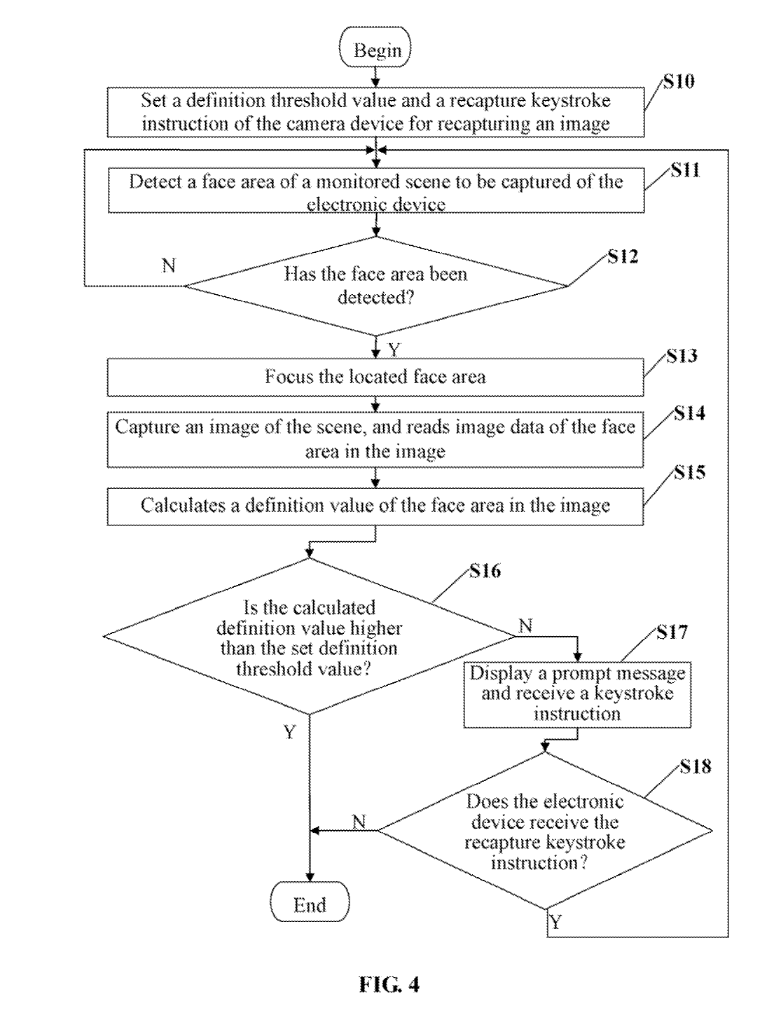

FIG. 4 is a flowchart of one embodiment of a method for capturing images in an electronic device. Depending on the embodiment, additional blocks may be added, others removed, and the ordering of the blocks may be changed.

In block S10, the setting module 400 sets a definition threshold value, sets a recapture keystroke instruction of the electronic device 1 for recapturing the image, and sets a hotkey of the electronic device 1 to invoke the recapture keystroke instruction. In some embodiments, the hotkey of the electronic device 1 may be any hotkey except for a camera button of the electronic device 1.

In block S11, the face detection module 401 detects a face area of a monitored scene.

In block S12, the face detection module 401 further determines whether the face area has been detected.

If the face area has been detected, in block S13, the focusing device 30 focuses the face area to make the face area clearer automatically. If the face area has not been detected, the procedure turns back to S11.

In block S14, the camera device 20 captures an image of the monitored scene, and the reading module 402 reads the face area in the image of the monitored scene captured by the camera device 20 and read image data of the face area in the image. The image data may include gray values of the face area.

In block S15, the calculation module 403 calculates a definition value of the face area in the image according to the read image data.

In block S16, the determination module 404 determines whether the calculated definition value is higher than the definition threshold value.

If the calculated definition value is lower than or equal to the definition threshold value, in block S17, the displaying module 405 displays a prompt message of recapturing the image on the display 10, and the receiving module 406 receives a keystroke instruction from an input system (e.g. keystrokes or virtual keystrokes) of the electronic device 1 according to user input. If the calculated definition value is higher than the definition threshold value, the procedure ends.

In block S18, the determination module 404 determines whether the received keystroke instruction is equal to the recapture keystroke instruction. If the received keystroke instruction is equal to the recapture keystroke instruction, the receiving module 406 may delete the image captured by the camera device 20, and the procedure returns to the block S11. If the received keystroke is not the hotkey, the procedure ends.

It should be emphasized that the described disclosed embodiments are merely possible examples of implementations, and set forth for a clear understanding of the principles of the present disclosure. Many variations and modifications may be made to the-described inventive embodiments without departing substantially from the spirit and principles of the present disclosure. All such modifications and variations are intended to be comprised herein within the scope of this disclosure and the-described disclosed embodiments, and the present disclosure is protected by the following claims.

What is claimed is:

1. An electronic device, comprising:
a camera device;
a display;
a storage system;
at least one processor; and
one or more programs stored in the storage system, executable by the at least one processor, the one or more programs comprising:
a face detection module operable to use the camera device to detect a face area of a monitored scene;
a reading module operable to read image data of the face area in an image of the monitored scene captured by the camera device, wherein the image data comprising the gray values;
a calculation module operable to calculate a definition value of the face area in the image, according to the read image data;
a displaying module operable to display a prompt message on the display, the message prompting the user to recapture the image, upon the condition that the calculated definition value is lower than or equal to a predetermined definition threshold value.

2. The electronic device as claimed in claim 1, wherein the one or more programs further comprise:
a setting module further operable to set a recapture keystroke instruction of the electronic device for recapturing the image.

3. The electronic device of claim 2, wherein the setting module is further operable to set a hotkey of the electronic device to invoke the recapture keystroke instruction, wherein the hotkey is except for a camera button of the electronic device.

4. The electronic device as claimed in claim 2, wherein the one or more programs further comprise:
a receiving module operable to receive a keystroke instruction from an input system of the electronic device after showing the prompt message.

5. The electronic device as claimed in claim 4, wherein the receiving module is further operable to delete the image captured by the camera device, in response that the received keystroke instruction is equal to the recapture keystroke instruction.

6. A computer-implemented method for capturing images of an electronic device, the electronic device comprising a camera device, the method comprising:
detecting a face area of a monitored scene using the camera device;
reading image data of the face area in an image of the monitored scene captured by the camera device, wherein the image data comprising the gray values;
calculating a definition value of the face area in the image, according to the read image data;
displaying a prompt message on the display of the electronic device, the message prompting the user to recapture the image, upon the condition that the calculated definition value is lower than or equal to a predetermined definition threshold value.

7. The method as claimed in claim 6, wherein the method further comprises:
setting a recapture keystroke instruction of the electronic device for recapturing the image.

8. The method as claimed in claim 7, wherein the method further comprises:
set a hotkey of the electronic device to invoke the recapture keystroke instruction, wherein the hotkey is except for a camera button of the electronic device.

9. The method as claimed in claim 7, wherein the method further comprises:
receiving a keystroke instruction from an input system of the electronic device after displaying the prompt message.

10. The method as claimed in claim 9, wherein the method further comprises:
deleting the image captured by the camera device, in response that the received keystroke instruction is equal to the recapture keystroke instruction.

11. A storage medium storing a set of instructions, the set of instructions capable of executed by a processor to perform a method for capturing images of an electronic device, the electronic device comprising a camera device, the method comprising:
reading image data of the face area in an image of the monitored scene captured by the camera device, wherein the image data comprising the gray values;
calculating a definition value of the face area in the image, according to the read image data;
calculating a definition value of the face area in the image;
display a prompt message on a display of the electronic device, the message prompting the user to recapture the image, upon the condition that the calculated definition value is lower than or equal to a predetermined definition threshold value.

12. The storage medium as claimed in claim 11, wherein the method further comprises:
setting a recapture keystroke instruction of the electronic device for recapturing the image.

13. The storage medium as claimed in claim 12, wherein the method further comprises:
setting a hotkey of the electronic device to invoke the recapture keystroke instruction, wherein the hotkey is except for a camera button of the electronic device.

14. The storage medium as claimed in claim 11, wherein the method further comprises:
receiving a keystroke instruction from an input system of the electronic device after displaying the prompt message.

15. The storage medium as claimed in claim 14, wherein the method further comprises:
deleting the image captured by the camera device, in response that the received keystroke instruction is equal to the recapture keystroke instruction.
